(19) United States
(12) Patent Application Publication
(10) Pub. No.: US 2021/0125160 A1
(43) Pub. Date: Apr. 29, 2021

(54) PERSONALIZED PROVIDER CONNECTIONS SUGGESTIONS

(71) Applicant: Intuit Inc., Mountain View, CA (US)

(72) Inventors: Roubing LU, Mountain View, CA (US); Elangovan SHANMUGAM, Mountain View, CA (US); Vishal Pramod AGGARWAL, Mountain View, CA (US); Gerald CARVALHO, Mountain View, CA (US)

(73) Assignee: Intuit Inc., Mountain View, CA (US)

(21) Appl. No.: 16/663,429

(22) Filed: Oct. 25, 2019

(51) Int. Cl. G06Q 20/10; G06F 16/23; G06F 16/2458; G06F 16/25; G06Q 40/00; G06K 9/00

(52) U.S. Cl. CPC G06Q 20/10; G06F 16/2379; G06F 16/2468; G06K 2209/01; G06Q 40/12; G06K 9/00469; G06F 16/252

(57) ABSTRACT

At least one processor may ingest transaction data of a user logged into a user account of a personal financial management (PFM) system. The transaction data may include descriptions of a plurality of transactions made using an account of the user. The at least one processor may scan the descriptions to identify, for each of the plurality of transactions, text indicative of at least one data provider. The at least one processor may compare the text with known data provider information to identify at least one data provider involved with at least one of the plurality of transactions. The at least one processor may link the user account to the at least one data provider identified by the comparing. The linking may cause data processed by the at least one data provider to be processed by the PFM system.

### BACKGROUND OF THE DISCLOSURE

In many computing scenarios, systems may connect with one another (e.g., through a network such as the Internet) to exchange data. In many cases, the systems are configured to connect with one another manually, automatically, or by some combination thereof. For example, in personal financial management (PFM) and/or data aggregation use cases, the PFM or data aggregation system may utilize one or more connections to one or more data providers. For example, a PFM user may wish to add connections to their account providers' systems so that the PFM system may access financial data processed by the account providers' systems. In many cases, a PFM app may include a user interface (UI) for adding a connection to customer's data providers which includes a standard/static list of providers for the user to select and connect with. This is a very primitive experience that requires a user to search through the list manually, and/or to input correct search terms, to identify their potential connections.

### BRIEF DESCRIPTION OF THE FIGURES

FIG. 1 shows a computing environment according to an embodiment of the present disclosure.

FIG. 2 shows a provider personalization process according to an embodiment of the present disclosure.

FIG. 3 shows a data provider identification process based on transactions according to an embodiment of the present disclosure.

FIG. 4 shows a data provider identification process based on clustering according to an embodiment of the present disclosure.

FIG. 5 shows a model building process according to an embodiment of the present disclosure.

FIGS. 6-8 show UI examples according to an embodiment of the present disclosure.

FIG. 9 shows a computing device according to an embodiment of the present disclosure.

### DETAILED DESCRIPTION OF SEVERAL EMBODIMENTS

Embodiments described herein may personalize and at least partially automate the process of connecting a system such as a PFM app to other systems such as a customer's data providers. For example, embodiments may generate and provide one or more personalized options for connecting to data providers. Embodiments may provide some options based on the popularity of the data provider, for example through analyzing user data to cluster the user with other, similar users and recommending data providers popular with the similar users. Embodiments may provide other options based on processing user-specific data. For example, the user may enter data into the PFM app and/or may connect to a first data source (e.g., a bank account system). The device executing the app and/or one or more servers in communication with the device may acquire this data (e.g., 90 days of transactions made using the bank account). The data may provide information about the user which may be used to place the user in a cluster and identify popular providers among the users in the cluster. Also, the data (e.g., the set of transactions) may provide several indications of other potential connections to this user. For example, a transaction set may include transactions involving other providers such as investments accounts, mortgage providers, bill pay providers, digital currency providers, and/or others. Using natural-language understanding (NLU), natural-language processing (NLP), matching algorithms, and/or other processing techniques, the disclosed embodiments may identify these additional providers. In some cases, the app may present a list of identified providers to the user so that he or she can select connections without additional search. In some cases, these connections may be highlighted in transaction pages within the app showing the user's list of transactions with a link to the potential provider, so that a user can connect from where they are instead of going to a specific search and connect interface. As more connections are completed (e.g., based on user selection of suggested connections), the data provided through these connections may be fed back into the system to help identify more connections.

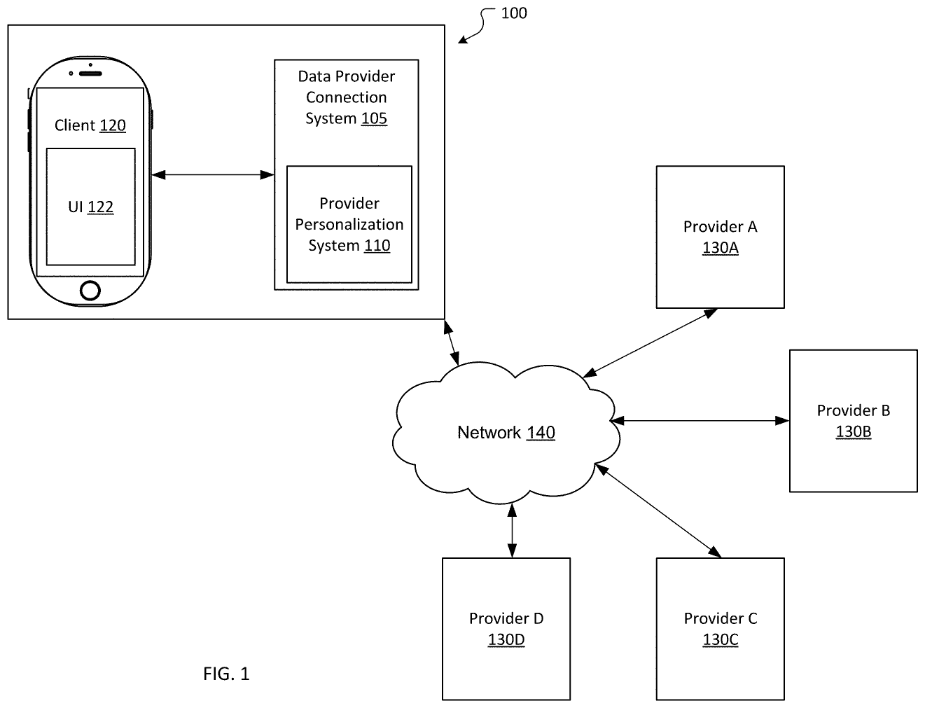

FIG. 1 shows a computing environment according to an embodiment of the present disclosure. The computing environment may include one or more devices in communication with one another through a network 140. Network 140 may include any public and/or private network, such as the Internet. The devices may include PFM system 100. PFM system 100 may include data provider connection system 105. Data provider connection system 105 may connect with data providers to obtain data therefrom. In some embodiments, data provider connection system 105 may include one or more options for selecting providers, such as user-driven searching and/or menu selection. To surface possible options for connection, data provider connection system 105 may include provider personalization system 110, which may include hardware, firmware, and/or software configured to generate personalized data provider connections as described in detail herein.

PFM system 100 may include client device 120, which may be configured to present UI 122 through which the personalized data provider connections may be presented and/or selected. In some embodiments, provider personalization system 110 may be a component of client device 120. In some embodiments, provider personalization system 110 may be provided by one or more separate computers from client device 120, such as one or more servers. In some embodiments, provider personalization system 110 may be provided by a combination of client device 120 and one or more separate computers, such as one or more servers. While system 100 of FIG. 1 is depicted as a PFM system for ease of explanation, any system configured to connect to data providers may be substituted for the PFM system and may include similar functionality for generating personalized data provider connections as described in detail herein. Moreover, while client device 120 is depicted as a mobile device with a mobile app in FIG. 1 for ease of illustration, client device 120 may be any type of computing device (e.g., personal computer, laptop, tablet, etc.), and may provide provider personalization system 110 functionality through a PFM app, a web browser, a desktop or tablet software product, etc.

At least some other devices accessible through network 140 may be data providers 130. A data provider 130 may be any computing system storing and/or otherwise processing data associated with one or more specific users and/or accounts and having one or more specific procedures or requirements for establishing a connection thereto. For example, a data provider 130 may be a bank server processing data associated with bank accounts. The bank server may require user ID, password, and/or other data to be submitted through an application programming interface (API) or other interface in a prescribed manner in order to gain access to data associated with a specific bank account, for example.

Computers storing and/or processing data related to bank accounts and/or other financial accounts are used as data provider 130 examples in this description due to their relevance to PFM system 100. However, any computing device acting as a custodian of any kind of data may be a data provider 130. For example, other data providers 130 with which the user may interact may include, but are not limited to, bill payees, digital currency systems, investment platforms, mortgage companies, loan sources (e.g., home loan, personal loan, car loan, etc.), credit issuing organizations, etc. Moreover, while four data providers 130A-130D are illustrated in FIG. 1, any number of data providers 130 may be accessible through network 140.

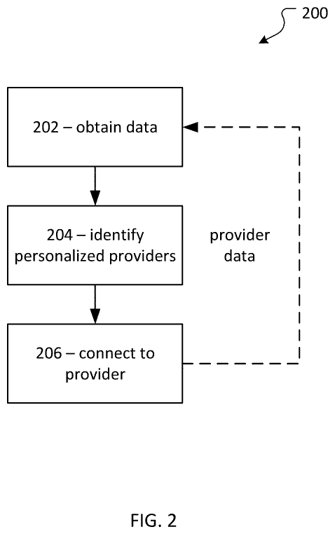

FIG. 2 shows a provider personalization process 200 according to an embodiment of the present disclosure. PFM system 100, including provider personalization system 110, may perform process 200 to make personalized data provider 130 recommendations within UI 122 and connect with recommended data providers 130. Process 200 is depicted at a high level in FIG. 2, and specific embodiments and/or options for components thereof (e.g., specific processing for identifying personalized data providers 130) are described in greater detail in subsequent figures.

At 202, PFM system 100 may obtain data which may be used to identify one or more data providers 130. For example, a user may input some information through UI 122, such as personal biographical information. Alternatively, or additionally, the user may select a first data provider 130A, for example by searching for the provider in the UI 122 without being given a recommendation. PFM system 100 may connect with data provider 130A and obtain the data from data provider 130A. For example, PFM system 100 may obtain the data using an API provided by data provider 130A and/or may download data from data provider 130A (e.g., a bank statement in .pdf format or other files).

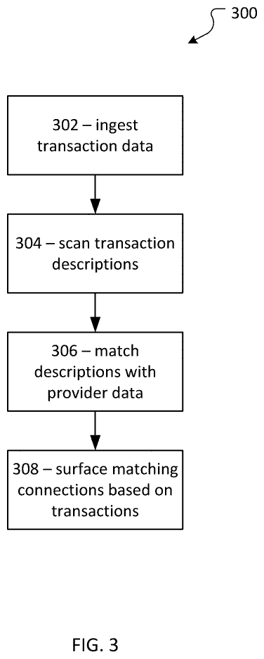

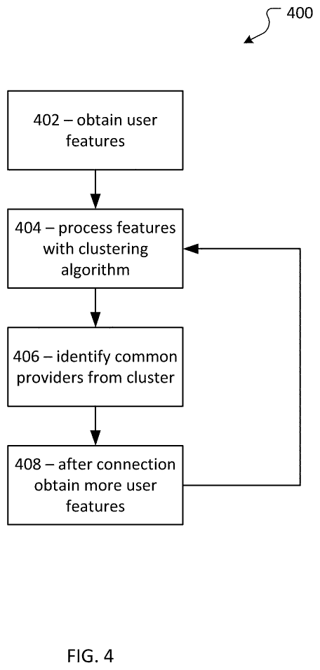

At 204, provider personalization system 110 may identify personalized data providers 130 from the data obtained at 202. For example, provider personalization system 110 may perform transaction processing as described below with respect to FIG. 3, clustering processing as described below with respect to FIG. 4, or a combination thereof. Based on this processing, provider personalization system 110 may identify one or more data providers 130 that may be of likely relevance to the user. UI 122 may present an interface providing functionality for connecting to the identified one or more data providers 130.

At 206, PFM system 100 may connect with one or more data providers 130 recommended at 204. PFM system 100 may connect automatically to identified data providers 130 and/or may connect to data providers 130 after receiving user selection and/or confirmation of the one or more data providers 130 through UI 122. For example, PFM system 100 may connect to a given data provider 130 using an API provided by the data provider 130.

Once connected to a data provider, PFM system 100 may obtain data therefrom and use the obtained data to repeat process 202. For example, data from data providers 130 added at 206 may be obtained through performing repeated processing at 202 and processed to identify additional data providers 130 at 204, which may be connected with at 206. The process 200 may be repeated when another data provider 130 is connected and/or periodically.

In some embodiments, provider personalization system 110 may be a component of PFM system 100 that may allow possible data provider 130 connections to be surfaced without user-directed searching, but users may still be able to connect with data providers 130 not suggested by provider personalization system 110 in some embodiments. For example, PFM system 100 may include provider personalization system 110 along with other systems allowing UI searching and/or menu selection of data providers 130 for connection.

FIG. 3 shows a data provider identification process 300 based on transactions according to an embodiment of the present disclosure. Provider personalization system 110 may perform process 300 to identify personalized data providers 130 (e.g., at 204 in process 200) based on previously obtained transaction data for a user. For example, provider personalization system 110 may perform process 300 after PFM system 100 has connected with a first data provider 130 (e.g., after user connection of a data provider as described above with respect to element 202 of process 200) and/or iteratively after process 200 has identified and added further data providers 130.

At 302, provider personalization system 110 may ingest transaction data. For example, as noted above PFM system 100 may have connected with a data provider 130 and obtained data from data provider 130. For example, PFM system 100 may obtain the data using an API provided by data provider 130 and/or may download data from data provider 130 (e.g., a bank statement in .pdf format or other files). In some cases, (e.g., in the case of a .pdf), provider personalization system 110 may perform optical character recognition (OCR) processing or similar processing to convert the data into text that can be processed as described below. Provider personalization system 110 may ingest the data from data provider 130 for processing. For example, provider personalization system 110 may collect recent transactions (e.g., all transactions in the past 90 days (or some other time interval), the last 200 transactions (or some other quantity), etc.) from the data obtained from data provider 130.

At 304, provider personalization system 110 may scan descriptions of transactions within the ingested transaction data. For example, the transaction data may include text describing a merchant, financial organization, or other vendor or provider; a payment type; a reference number; a transaction identifier; other information; or any combination thereof. Provider personalization system 110 may tokenize or otherwise extract words, phrases, numbers, etc. from the ingested transaction data in some cases. In some embodiments, provider personalization system 110 may extract terms that may be potentially relevant to data provider 130 identification (e.g., text) and/or remove likely irrelevant terms (e.g., numbers).

At 306, provider personalization system 110 may match the descriptions from 304 with known provider data to determine whether any of the descriptions are indicative of one or more data providers 130. For example, provider personalization system 110 may maintain or obtain a list of known data provider 130 names. Provider personalization system 110 may compare the known data provider 130 names with the descriptions from 304 to identify one or more known data provider 130 names within the descriptions from 304. In some embodiments, provider personalization system 110 may use a fuzzy matching algorithm such as identifying near-matches within an edit distance threshold. This may compensate for tendencies of some data provider 130 names to be truncated or otherwise altered in transaction records. If any of the known data provider 130 names are found within the descriptions from 304, they may be flagged as potentially relevant data providers 130 to the user whose transactions are being analyzed.

While bank statements and/or transactions are used in this example, other data types may be ingested and scanned. For example, data provider 130 accessed at 302 may be a credit reporting agency. PFM system 100 may obtain the data using an API provided by data provider 130 and/or may download data from data provider 130 (e.g., a credit report in .pdf format or other files) and perform OCR processing or similar processing thereon. The credit report data obtained through the API or from the processed document(s) may be scanned at 304 and analyzed for known data provider 130 name matches at 306.

At 308, provider personalization system 110 may surface matching, potentially relevant data providers 130 for connection. For example, these data providers 130 may be identified based on transaction data analyzed at 306. For example, provider personalization system 110 may cause UI 122 to display options for connecting to the potentially relevant data providers 130 without requiring the user to search for them. A user may be able to select one or more of the displayed options and enter any necessary information for connecting with the associated data provider 130 (e.g., a username and/or password for an account the user has with the data provider 130). PFM system 100 may connect to the data provider 130, for example as discussed above in process 200.

FIG. 4 shows a data provider identification process 400 based on clustering according to an embodiment of the present disclosure. Provider personalization system 110 may perform process 400 to identify personalized data providers 130 (e.g., at 204 in process 200) based on similarities between the user and other users. For example, provider personalization system 110 may perform process 400 after PFM system 100 has gathered some data about the user (e.g., at 202 in process 200). In some embodiments, provider personalization system 110 may perform both process 300 and process 400 to identify personalized data providers 130 (e.g., at 204 in process 200) and, thereby, potentially provide more connection options to the user than performing either process 300 or process 400 alone.

At 402, provider personalization system 110 may obtain one or more user features that may be used to classify the user. For example, the user may be prompted to create an account and/or otherwise enter some biographical information through the UI 122 of the PFM app. The user may enter data such as age, gender, income, geographic location, and/or other biographical information.

In some embodiments, provider personalization system 110 may use transaction data from the user as well. For example, if process 300 is also being performed, provider personalization system 110 may obtain the transaction data ingested at 302. If process 300 is not being performed, provider personalization system 110 may ingest transaction data. For example, as noted above PFM system 100 may have connected with a data provider 130 and obtained data from data provider 130. For example, PFM system 100 may obtain the data using an API provided by data provider 130 and/or may download data from data provider 130 (e.g., a bank statement in .pdf format or other files). In some cases, (e.g., in the case of a .pdf), provider personalization system 110 may perform optical character recognition (OCR) processing or similar processing to convert the data into text that can be processed as described below. Provider personalization system 110 may ingest the data from data provider 130 for processing. For example, provider personalization system 110 may collect recent transactions (e.g., all transactions in the past 90 days (or some other time interval), the last 200 transactions (or some other quantity), etc.) from the data obtained from data provider 130.

From the transaction data, provider personalization system 110 may obtain user features that may be suggestive of a group or groups to which they can be associated. For example, provider personalization system 110 may obtain features such as account types, frequency of transactions, average monthly spending, automated clearing house (ACH) payments, recurring payments, and/or a corpus of one or more transaction descriptions. For example, if process 300 is also being performed, provider personalization system 110 may obtain the user features from the scanned data generated at 304. If process 300 is not being performed, provider personalization system 110 may scan descriptions of transactions within the ingested transaction data. For example, the transaction data may include text describing a merchant, financial organization, or other vendor or provider; a payment type; a reference number; a transaction identifier; other information; or any combination thereof. Provider personalization system 110 may tokenize or otherwise extract words, phrases, numbers, etc. from the ingested transaction data in some cases. Within the scanned data, provider personalization system 110 may identify terms associated with the features being investigated, such as terms indicating account types, ACH payments, descriptions (including recurring descriptions in some embodiments), etc. Provider personalization system 110 may also identify amounts associated with some or all of these transactions to calculate monthly spending, spending with particular providers, etc.

At 404, provider personalization system 110 may process the user features identified at 402 using a clustering algorithm to identify one or more clusters to which the user may be assigned. For example, a cluster model may have been previously generated (e.g., according to process 500 described below or some other process). The cluster model may have been generated by executing a clustering algorithm, such as a machine learning (ML) algorithm configured to input features and output a set of clusters based on the features. Examples of clustering algorithms that may be used to generate such a model may include, but are not limited to, expectation maximization, K-means, and/or hierarchical clustering algorithms. Provider personalization system 110 may execute the same clustering algorithm used to generate the model, taking in at least the user features identified at 402 as inputs, and obtaining data indicating which cluster or clusters within the model most closely match the user based on the user features. Provider personalization system 110 may determine that the user is a member of the indicated cluster or clusters based on the clustering.

At 406, provider personalization system 110 may identify one or more data providers 130 to recommend to the user based on the processing at 404. For example, each cluster may have one or more data providers 130 associated therewith that may have been identified during the model building process (e.g., according to process 500 described below or some other process). These associated data providers 130 may be data providers 130 that are commonly used by members of the cluster, for example. Provider personalization system 110 may surface the associated data providers 130 for connection. For example, provider personalization system 110 may cause UI 122 to display options for connecting to the associated data providers 130 without requiring the user to search for them. A user may be able to select one or more of the displayed options and enter any necessary information for connecting with the associated data provider 130 (e.g., a username and/or password for an account the user has with the data provider 130). PFM system 100 may connect to the data provider 130, for example as discussed above in process 200.

At 408, provider personalization system 110 may obtain more user features after connection by the user to any of the surfaced data providers 130. For example, once PFM system 100 connects to the data provider 130 as described at 406, provider personalization system 110 may obtain user features from the data held by the newly connected data provider 130 in the manner described above with respect to 402. If any new user features are found through this process, provider personalization system 110 may repeat processing at 404 and 406 to reevaluate the user's cluster associations and, if the reevaluating finds the user to be associated with any different clusters, identify one or more different data providers 130 to recommend based on the different clusters.

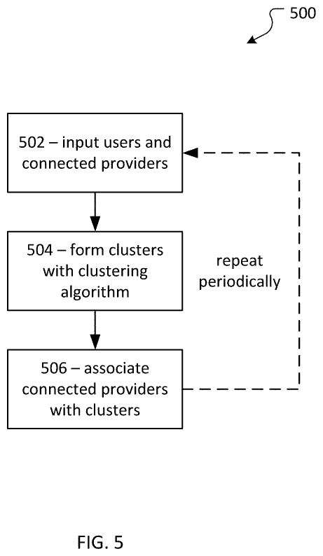

FIG. 5 shows a model building process 500 according to an embodiment of the present disclosure. PFM system 100 may perform process 500 to generate the cluster model used to identify data providers 130 in process 400, for example. To build the model, PFM system 100 may utilize data provided by users of the PFM system 100. In some embodiments, this data may be anonymized before being used to build the model.

At 502, user features for a plurality of respective users and information identifying respective data providers 130 connected to each respective users may be input. The user features may be the same types of features identified at 402 in process 400 as described above, for example, and may include biographical data and/or data obtained based on transaction data.

At 504, PFM system 100 may perform clustering of the user features obtained at 502. For example, as noted above, data processing service 130 may use expectation maximization, K-means, and/or hierarchical clustering algorithms to generate clusters of users having similar user features. However, data processing service 130 is not limited to these specific algorithms, and other clustering algorithms may be used in various embodiments. These clusters may be stored in a memory accessible to PFM system 100.

At 506, PFM system 100 may examine the users in each cluster to identify commonly connected, associated data providers 130 for the respective users of each given cluster. For example, in each cluster, PFM system 100 may identify connected data providers 130 of each user therein. Each connected data provider 130 appearing more frequently than some threshold percentage, or the most frequently appearing connected data providers 130 (e.g., the top three or top five or some other top amount), may be identified as an associated data provider 130 for the cluster. These identified associated data providers 130 may be stored as being associated with the clusters in the memory accessible to PFM system 100.

As more users connect with PFM system 100, more data may become available about what data providers 130 are popular with users, and about what user features are evident among the user base. Accordingly, as shown in FIG. 5, process 500 may be repeated periodically or occasionally in order to update clusters and/or associated data providers 130 as reflected in the latest data available to PFM system 100.

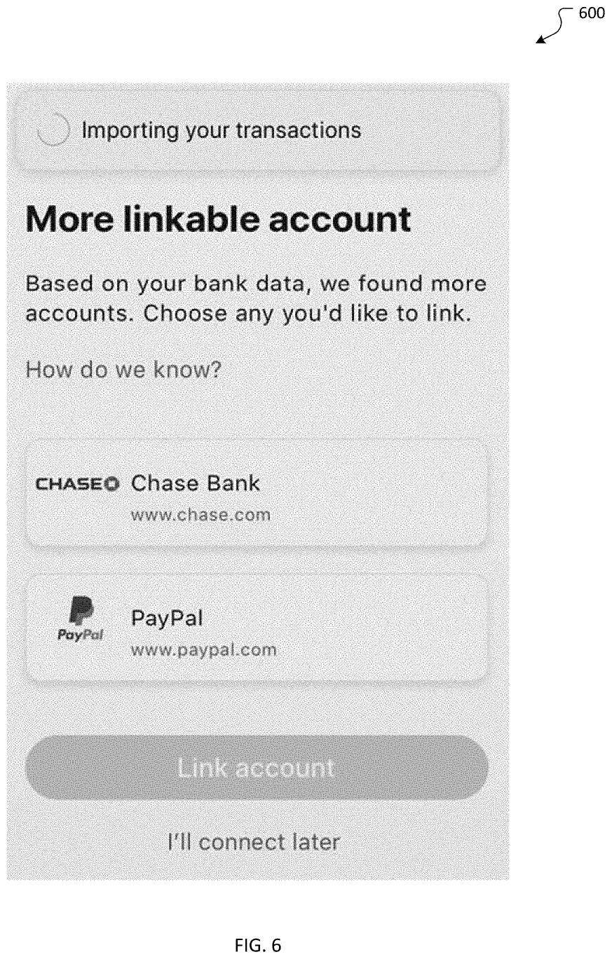

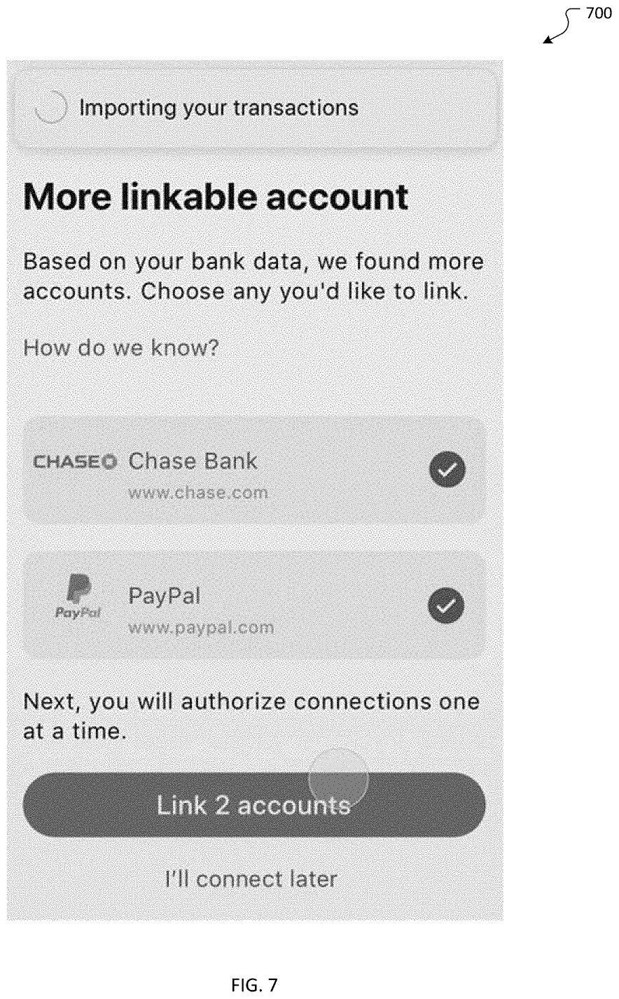

FIGS. 6-8 show UI 122 examples 600-800 according to an embodiment of the present disclosure. For example, in screen 600 of FIG. 6, UI 122 is displaying data provider 130 selection options for data providers 130 identified through process 300. As shown in screen 700 of FIG. 7, a user may select one or more of the displayed data provider 130 selection options to cause PFM system 100 to connect with the selected data providers 130.

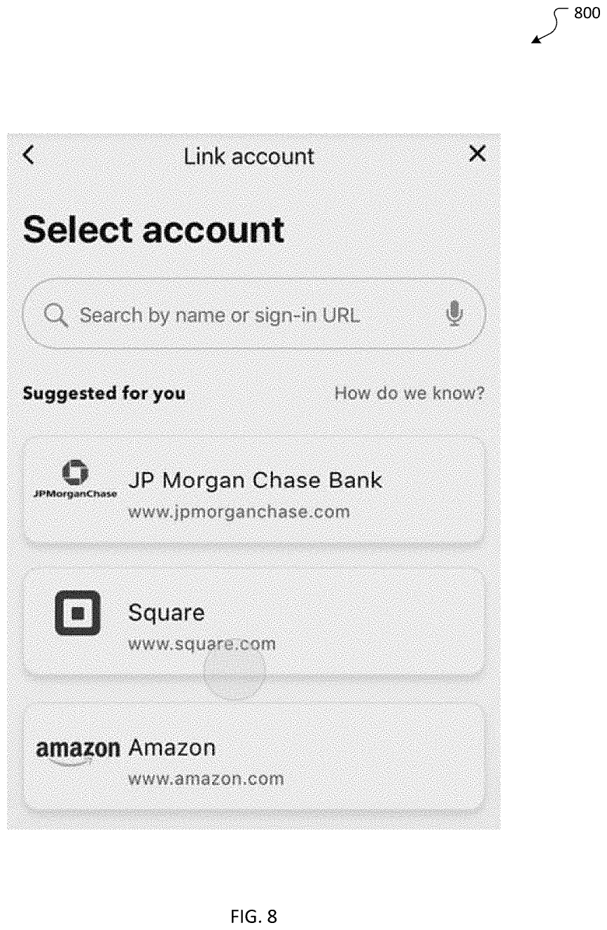

In screen 800 of FIG. 8, UI 122 is displaying data provider 130 selection options for data providers 130 identified through process 400. As shown, these options may be shown as suggestions without any user input (e.g., without anything being entered into the search dialog).

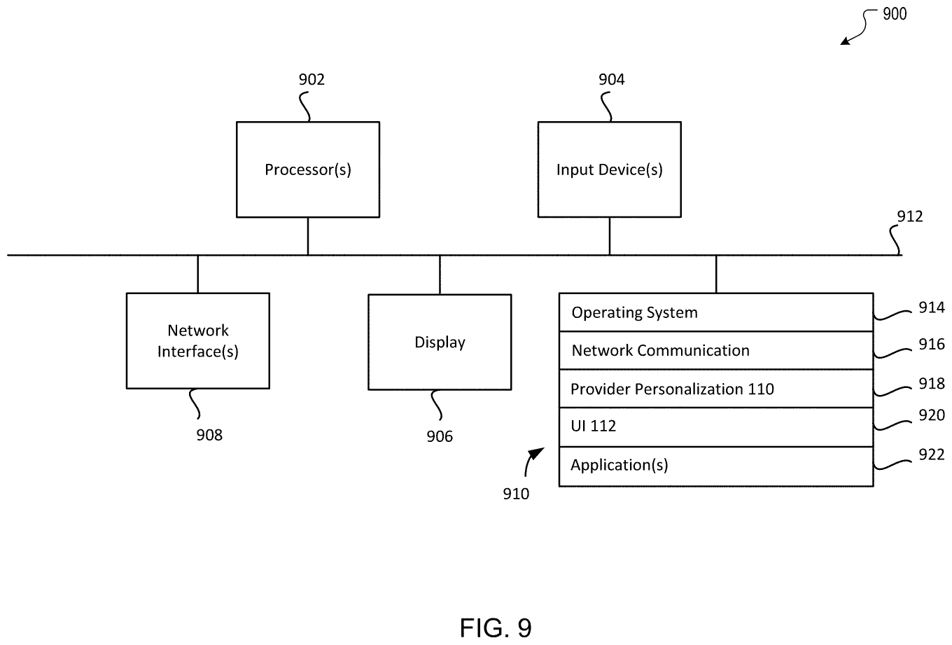

FIG. 9 shows a computing device 900 according to an embodiment of the present disclosure. For example, computing device 900 may function as client 120 and/or one or more servers or other devices configured to function as PFM system 100 or portions thereof. Computing device 900 may be implemented on any electronic device that runs software applications derived from compiled instructions, including without limitation personal computers, servers, smart phones, media players, electronic tablets, game consoles, email devices, etc. In some implementations, computing device 900 may include one or more processors 902, one or more input devices 904, one or more display devices 906, one or more network interfaces 908, and one or more computer-readable mediums 910. Each of these components may be coupled by bus 912, and in some embodiments, these components may be distributed among multiple physical locations and coupled by a network.

Display device 906 may be any known display technology, including but not limited to display devices using Liquid Crystal Display (LCD) or Light Emitting Diode (LED) technology. Processor(s) 902 may use any known processor technology, including but not limited to graphics processors and multi-core processors. Input device 904 may be any known input device technology, including but not limited to a keyboard (including a virtual keyboard), mouse, track ball, and touch-sensitive pad or display. Bus 912 may be any known internal or external bus technology, including but not limited to ISA, EISA, PCI, PCI Express, NuBus, USB, Serial ATA or FireWire. Computer-readable medium 910 may be any medium that participates in providing instructions to processor(s) 902 for execution, including without limitation, non-volatile storage media (e.g., optical disks, magnetic disks, flash drives, etc.), or volatile media (e.g., SDRAM, ROM, etc.).

Computer-readable medium 910 may include various instructions 914 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 904; sending output to display device 906; keeping track of files and directories on computer-readable medium 910; controlling peripheral devices (e.g., disk drives, printers, etc.) which can be controlled directly or through an I/O controller; and managing traffic on bus 912. Network communications instructions 916 may establish and maintain network connections (e.g., software for implementing communication protocols, such as TCP/IP, HTTP, Ethernet, telephony, etc.).

Provider personalization instructions 918 may include instructions that enable computing device 900 to perform provider personalization system 110 functionality as described herein. UI instructions 920 may include instructions that enable computing device 900 to perform UI 112 functionality as described herein. Application(s) 922 may be an application that uses or implements the processes described herein and/or other processes. The processes may also be implemented in operating system 914.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method of linking electronically accessible accounts comprising:
ingesting, by at least one processor, transaction data of a user logged into a user account of a personal financial management (PFM) system, the transaction data including descriptions of a plurality of transactions made using a financial account of the user;
scanning, by the at least one processor, the descriptions to identify, for each of the plurality of transactions, text indicative of at least one data provider;
comparing, by the at least one processor, the text with known data provider information to identify at least one data provider involved with at least one of the plurality of transactions; and
linking, by the at least one processor, the user account to the at least one data provider identified by the comparing, wherein the linking causes data processed by the at least one data provider to be processed by the PFM system.

2. The method of claim 1, further comprising:
presenting, by the at least one processor, information describing the at least one data provider identified by the comparing within a user interface (UI) of the user account; and
receiving, at the at least one processor through the UI, a command to link the user account to the at least one data provider identified by the comparing, wherein the linking is performed in response to the receiving.

3. The method of claim 1, wherein the ingesting comprises connecting with a financial account computer using an application programming interface (API) specific to the financial account.

4. The method of claim 1, wherein the ingesting comprises performing optical character recognition (OCR) on a document associated with the financial account.

5. The method of claim 1, wherein the comparing comprises identifying an exact match between a first term in the known data provider information and a second term in the text, identifying a fuzzy match between a third term in the known data provider information and a fourth term in the text, or a combination thereof.

6. The method of claim 1, further comprising:
obtaining, by the at least one processor, at least one user feature from data associated with the user account;
processing, by the at least one processor, a clustering algorithm using the at least one user feature and a model as inputs to identify at least one cluster to which the user belongs;
identifying, by the at least one processor, at least one associated data provider associated with the identified at least one cluster; and
linking, by the at least one processor, the user account to the at least one associated data provider, wherein the linking causes data processed by the at least one associated data provider to be processed by the PFM system.

7. The method of claim 6, further comprising:
presenting, by the at least one processor, information describing the at least one associated data provider identified by the comparing within a user interface (UI) of the user account; and
receiving, at the at least one processor through the UI, a command to link the associated user account to the at least one data provider identified by the comparing, wherein the linking of the at least one associated user account is performed in response to the receiving.

8. The method of claim 6, wherein the inputs further include at least a portion of the transaction data, the text, or a combination thereof.

9. A method of linking electronically accessible accounts comprising:
obtaining, by at least one processor, at least one user feature from data associated with a user account of a personal financial management (PFM) system;
processing, by the at least one processor, a clustering algorithm using the at least one user feature and a model as inputs to identify at least one cluster to which the user belongs;
identifying, by the at least one processor, at least one associated data provider associated with the identified at least one cluster; and
linking, by the at least one processor, the user account to the at least one associated data provider, wherein the linking causes data processed by the at least one associated data provider to be processed by the PFM system.

10. The method of claim 9, further comprising:
presenting, by the at least one processor, information describing the at least one associated data provider identified by the comparing within a user interface (UI) of the user account; and
receiving, at the at least one processor through the UI, a command to link the associated user account to the at least one data provider identified by the comparing, wherein the linking of the at least one associated user account is performed in response to the receiving.

11. The method of claim 9, further comprising ingesting, by the at least one processor, transaction data of a user logged into the user account, the transaction data including descriptions of a plurality of transactions made using a financial account of the user, wherein the inputs further include at least a portion of the transaction data.

12. The method of claim 9, further comprising training, by the at least one processor, the model using the clustering algorithm, the training being based on data from a plurality of other user accounts of the PFM system.

13. A personal financial management (PFM) system configured to link to other electronically accessible accounts, the system comprising:
at least one processor configured to:
ingest transaction data of a user logged into a user account of the PFM system, the transaction data including descriptions of a plurality of transactions made using a financial account of the user;
scan the descriptions to identify, for each of the plurality of transactions, text indicative of at least one data provider;
compare the text with known data provider information to identify at least one data provider involved with at least one of the plurality of transactions; and
link the user account to the at least one data provider identified by the comparing, wherein the linking causes data processed by the at least one data provider to be processed by the PFM system.

14. The system of claim 13, further comprising:
a user interface (UI) display device, wherein the at least one processor is further configured to:
present, by the UI device, information describing the at least one data provider identified by the comparing; and
receive, through the UI device, a command to link the user account to the at least one data provider identified by the comparing, wherein the linking is performed in response to the receiving.

15. The system of claim 13, wherein the ingesting comprises connecting with a financial account computer using an application programming interface (API) specific to the financial account.

16. The system of claim 13, wherein the ingesting comprises performing optical character recognition (OCR) on a document associated with the financial account.

17. The system of claim 13, wherein the comparing comprises identifying an exact match between a first term in the known data provider information and a second term in the text, identifying a fuzzy match between a third term in the known data provider information and a fourth term in the text, or a combination thereof.

18. The system of claim 13, wherein the at least one processor is further configured to:
obtain at least one user feature from data associated with the user account;
process a clustering algorithm using the at least one user feature and a model as inputs to identify at least one cluster to which the user belongs;
identify at least one associated data provider associated with the identified at least one cluster; and
link the user account to the at least one associated data provider, wherein the linking causes data processed by the at least one associated data provider to be processed by the PFM system.

19. The system of claim 18, further comprising:
a user interface (UI) display device, wherein the at least one processor is further configured to:
present, by the UI device, information describing the at least one associated data provider identified by the comparing; and
receive, through the UI device, a command to link the associated user account to the at least one data provider identified by the comparing, wherein the linking of the at least one associated user account is performed in response to the receiving.

20. The system of claim 18, wherein the inputs further include at least a portion of the transaction data, the text, or a combination thereof.
